(19) United States
(12) Patent Application Publication
(10) Pub. No.: US 2010/0332190 A1
(43) Pub. Date: Dec. 30, 2010

(54) METHOD AND APPARATUS FOR NOTIFYING SENSOR OBSERVATION DATA

(75) Inventors: Shunsuke YAMAGUCHI, Kawasaki (JP); Masahiko Murakami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/822,670

(22) Filed: Jun. 24, 2010

(30) Foreign Application Priority Data
Jun. 29, 2009 (JP) 2009-154290

(51) Int. Cl. G06F 15/00; G06F 17/40

(52) U.S. Cl. 702/187

(57) ABSTRACT

An apparatus and method for notifying observation data to an application program which includes a memory which stores observation data received from a sensor and time information corresponding to the observation data are provided. The apparatus includes an evaluation-data calculating unit which calculates amount-of-change evaluation data based on the received newest observation data and former observation data notified to the application program, a determination unit which determines whether the amount-of-change evaluation data is greater than or equal to reference change amount, and a notification unit which notifies the observation data received from the sensor to the application program when the determination unit determines that the amount-of-change evaluation data is greater than or equal to the reference change amount.

### CROSS-REFERENCE TO RELATED APPLICATION

This application is related to and claims priority to Japanese Patent Application No. 2009-154290, filed on Jun. 29, 2009, incorporated herein by reference.

### BACKGROUND

1. Field

The embodiments discussed herein are directed to a method for notifying observation data observed by a sensor to an application program.

2. Description of the Related Art

In some systems including a sensor that observes an object and outputs observation data and a computer connected to the sensor, an application program implemented in the computer processes observation data observed by the sensor on reception of notification of the observation data.

A problem of such systems is that what time intervals and conditions the sensor observation data should be notified to the application program.

For example, too frequent notification will increase a load on the application program, thus sometimes causing a delay in processing.

On the other hand, increasing the notification interval to decrease a load on the application program will hinder obtaining observation data necessary for processing even if the observation data changes in a short time and the application program should perform some process.

### SUMMARY

It is an aspect of the embodiments discussed herein to provide a method and apparatus for notifying sensor observation data.

The aspects can be attained by an apparatus for notifying observation data to an application program that includes a memory which stores observation data received from a sensor and time information corresponding to the observation data. The apparatus also includes an evaluation-data calculating unit which calculates amount-of-change evaluation data based on the received newest observation data and former observation data notified to the application program, a determination unit which determines whether the amount-of-change evaluation data is greater than or equal to reference change amount, and a notification unit which notifies the observation data received from the sensor to the application program when the determination unit determines that the amount-of-change evaluation data is greater than or equal to the reference change amount.

The aspects can be attained by a notifying method including storing the observation data received from the sensor and time information corresponding to the observation data, calculating notification time intervals, for each amount of change in observation data, based on the observation data and the time information, in a case where the observation data is notified to the application program only when the observation data changes by a value which is greater than or equal to the amount of change in observation data, storing the calculated notification time intervals in association with each of the amount of change, obtaining a designated notification time interval from the application program, specifying the smallest notification time interval which is greater than or equal to the obtained designated notification time interval from among the notification time intervals, specifying an amount of change stored in association with the specified notification time interval as a reference change amount, on receiving newest observation data from the sensor, calculating amount-of-change evaluation data based on the newest observation data and observation data notified to the application program at last notification, determining whether the calculated amount-of-change evaluation data is greater than or equal to the specified reference change amount; and notifying the observation data received from the sensor to the application program, when it is determined in the determination that the amount-of-change evaluation data is greater than or equal to the reference change amount.

The object and advantages of the invention will be realized and attained by the elements and combinations particularly pointed out in the claims.

It is to be understood that both the foregoing general description and the following detailed description are exemplary and explanatory and are not restrictive of the invention, as claimed. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a related art.

FIG. 2 illustrates a related art.

FIG. 3 illustrates an embodiment.

FIG. 4 illustrates exemplary hardware of a system of the embodiment.

FIG. 5 illustrates an exemplary process of an observation-data collecting section.

FIG. 6 illustrates an example of data stored in an observation-data DB.

FIG. 7 illustrates an amount-of-change-DB creating process.

FIG. 8 illustrates a first notification counting process.

FIG. 9 illustrates the a notification counting process.

FIG. 10 illustrates a first example of data stored in an amount-of-change DB.

FIG. 11 illustrates a first process example of a notification processing section.

FIG. 12 illustrates a first example of data stored in a notification time DB.

FIG. 13 illustrates the first process example of the notification processing section.

FIG. 14 illustrates an example of data stored in a cache.

FIG. 15 illustrates the process of an amount-of-change calculating section.

FIG. 16 illustrates a second example of data stored in the amount-of-change DB.

FIG. 17 illustrates a second process example of the notification processing section.

FIG. 18 illustrates a second example of data stored in the notification time DB.

FIG. 19 illustrates a third process example of the notification processing section.

FIG. 20 illustrates a second notification counting process.

FIG. 21 illustrates a third process example of the notification processing section.

FIG. 22 illustrates a an exemplary computer used in an embodiment.

### DETAILED DESCRIPTION OF THE EMBODIMENTS

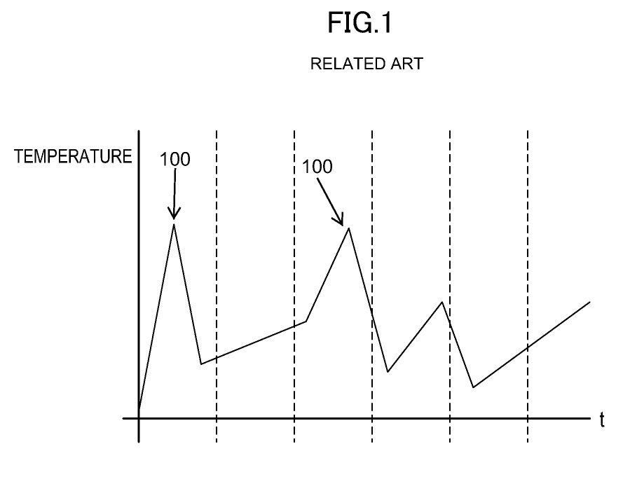

For example, assume that time-varying observation data, such as temperature, as indicated on the line graph in FIG. 1, is notified to an application program. If the observation data is regularly notified in accordance with the data-processing time interval of the application program indicated by the timing indicated by the dotted line, sudden changes of the observation data, such as peaks 100, which appear during a period in which no notification is made are not notified to the application program.

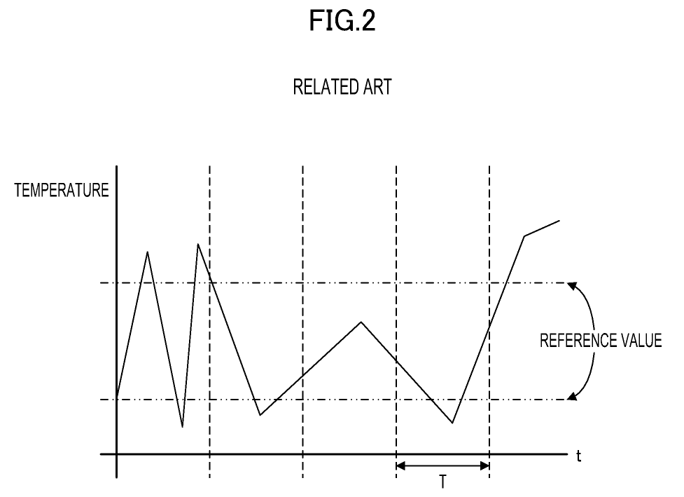

An upper-limit reference value and a lower-limit reference value of the observation data may be set, as indicated on the graph in FIG. 2, and notification may be made when the temperature exceeds the upper-limit reference value and falls below the lower-limit reference value. However, notification is sometimes made by a number of times exceeding the data processing capacity of the application program.

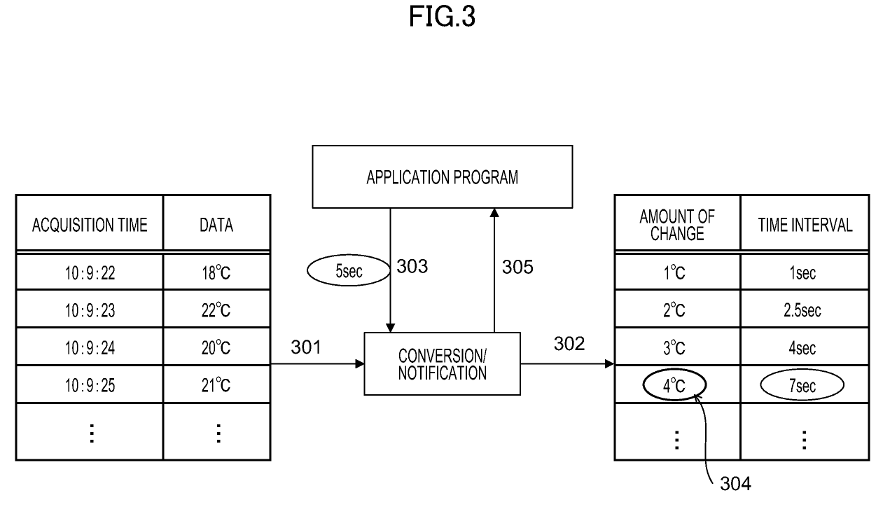

As illustrated in FIG. 3, on reception of observation data from a sensor, the observation data and observation-data observation time or reception time are stored in an observation-data DB 102 (operation 301). Then, notification time intervals are calculated for each of observation data change amounts.

In other words, notification time intervals that are ensured when the observation data has not changed by certain amount, are calculated, based on the stored observation data and reception time, for each change of the observation data (for each of temperatures 1° C., 2° C., 3° C., and 4° C. in FIG. 3). And the notification time intervals are stored in an amount-of-change DB 104 (operation 302).

Thereafter, when a designated notification time interval is notified from the application program (operation 303), the smallest amount of change in observation data that is greater than or equal to the notification time intervals designated by the application program is specified with reference to the data of notification time intervals of each amount of change (operation 304). In the example of FIG. 1, if an instruction to ensure a notification time interval of 5 sec. is given from the application program, 4° C. is specified as the amount of change in observation data at which observation data is notified at a time interval longer than the notification time interval.

If the difference between the observation data from the sensor and the observation data at the last notification is greater than or equal to the specified amount, the observation data is notified to the application program (operation 305).

This process allows an amount of change suitable for determining the timing of notification of observation data to be specified depending on the history of the observation data of an object in consideration of time necessary for the application program to process the observation data. This allows the application program to be notified of observation data at appropriate time intervals.

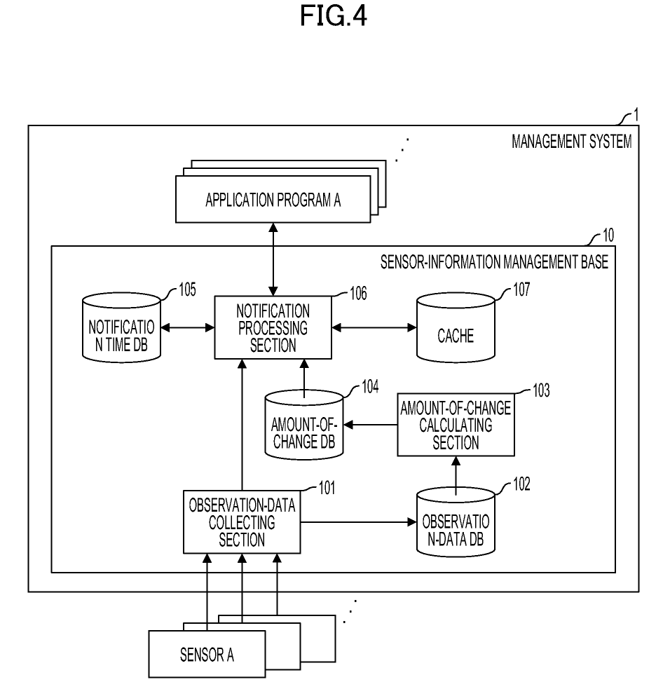

FIGS. 4 to 21 illustrate an exemplary embodiment. A management system 1 connects to a plurality of sensors. The management system 1 processes observation data from, for example, sensors A to N (N is any positive integer). The management system 1 includes application programs A to M (M is any positive integer) that performs predetermined processes on the observation data from, for example, the sensors A to N. The management system 1 includes a sensor-information management base 10 that is a platform that receives observation data from, for example, the sensors A to N, and notifies the observation data to necessary ones of the application programs A to M at appropriate timing.

The sensor-information management base 10 includes an observation-data collecting section 101 that collects observation data from the sensors A to N. The sensor-information management base 10 includes the observation-data DB 102 that stores the observation data collected by the observation-data collecting section 101, an amount-of-change calculating section 103 that calculates notification time intervals of individual reference change amount amounts using the data stored in the observation-data DB 102, the amount-of-change DB 104 that stores the data calculated by the amount-of-change calculating section 103, a notification processing section 106 that performs the notification process of the observation data notified from the observation-data collecting section 101 to the application programs A to M, a notification time DB 105 that stores data of notification time intervals etc. of the application programs A to M, and a cache 107 that temporarily stores the observation data received from the observation-data collecting section 101.

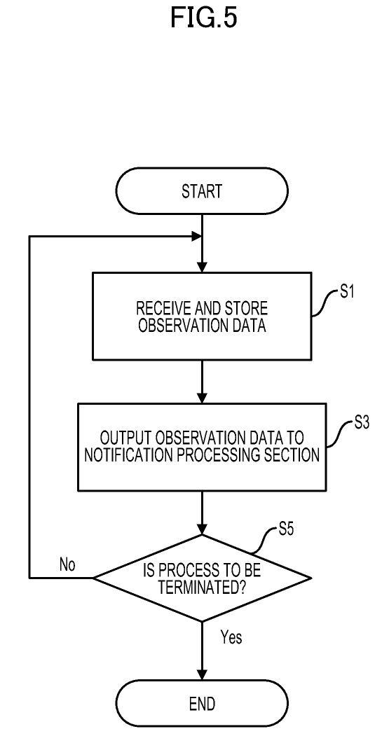

The process of the observation-data collecting section 101 is illustrated in FIG. 5. On reception of observation data (for example, an observation data and observation time pair, sometimes, only observation data. In this case, the observation-data collecting section 101 associates observation data with reception time.) from any of the sensors A to N, the observation-data collecting section 101 stores the observation data in the observation-data DB 102 for the individual sensors (operation S1).

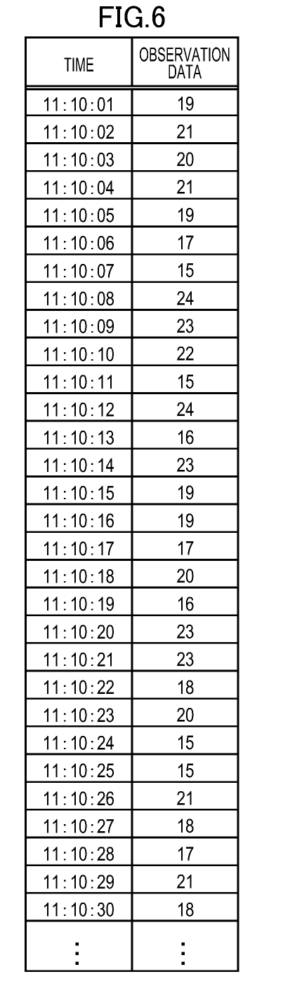

The observation-data DB 102 stores data, as indicated in FIG. 6, for each sensor. In the example of FIG. 6, observation data, which is temperature, is registered for each time. Assuming that positional data is observation data, more values, such as an x-coordinate and a y-coordinate or longitude, latitude, and altitude, may be stored.

The observation-data collecting section 101 outputs the received observation data and sensor IDs to the notification processing section 106 (operation S3). On reception of the observation data from the observation-data collecting section 101, the notification processing section 106 stores the observation data in the cache 107. A process for determining whether the observation data stored in the cache 107 is to be notified to the application programs A to M will be described later. The above process may be repeated until an instruction to terminate the process is given from an administrator or the like (operation S5).

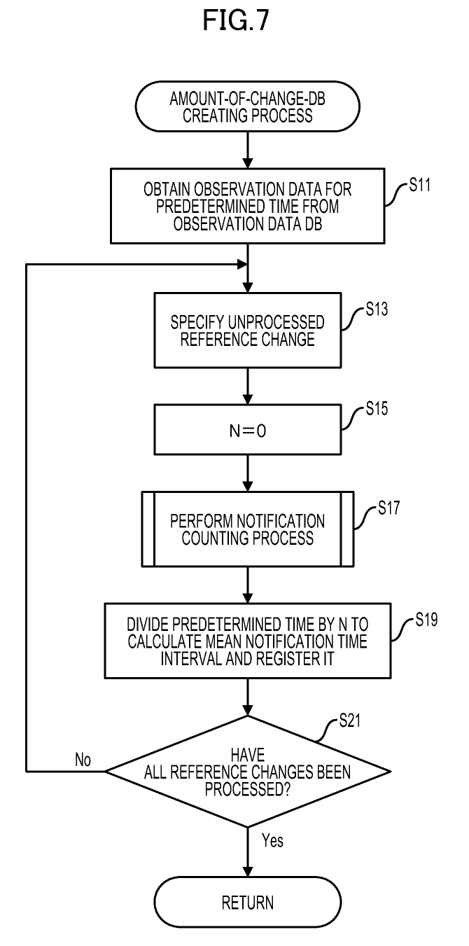

An exemplary amount-of-change DB creating process performed by the amount-of-change calculating section 103 is illustrated in FIGS. 7 to 10. The processes in FIGS. 7 to 10 may be performed in accordance with an instruction from an administrator. Alternatively, the processes may be performed in accordance with the process of re-creating the amount-of-change DB, for example, at regular intervals may be performed, as will be described below.

The exemplary processes in FIGS. 7 to 10 are for one sensor. When a plurality of sensors is connected, the following process may be performed for each sensor.

The amount-of-change calculating section 103 reads observation data for, for example, a predetermined time from the present time from the observation-data DB 102 (operation S11). Here, for example, the data shown in FIG. 6 may be obtained.

The amount-of-change calculating section 103 specifies one unprocessed reference change amount from among preset reference change amounts (operation S13). For example, the reference change amounts are preset in the form of, for example, 1° C. to 10° C. Alternatively, all reference change amounts (in the same example, 1° C., 2° C., 3° C., 4° C., 5° C., 6° C., 7° C., 8° C., 9° C., and 10° C.) may be designated, or alternatively, a concrete unprocessed reference change amount may be specified in accordance with another setting rule every time operation S13 is performed. Then, a counter N for counting the number of times of notification is reset to 0 (operation S15).

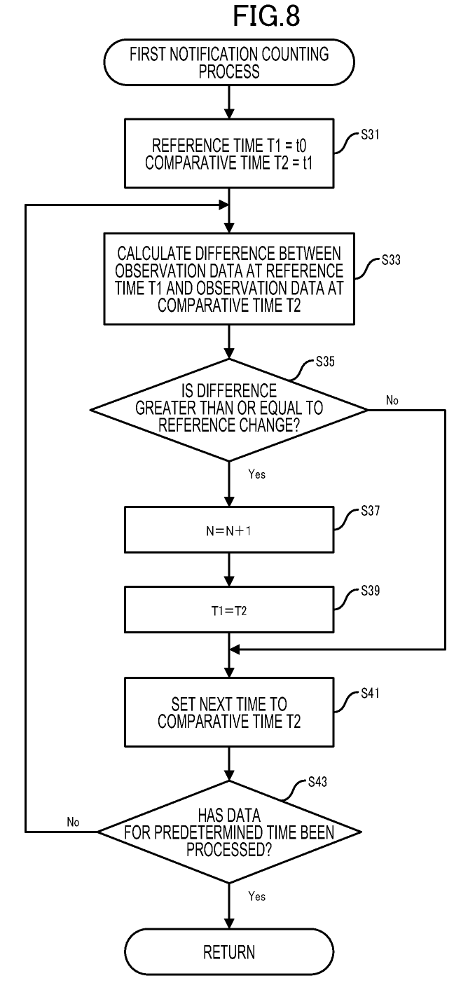

The amount-of-change calculating section 103 performs a notification counting process for the individual reference change amounts (operation S17). The notification counting process will be specifically described with reference to FIGS. 8 to 10.

The amount-of-change calculating section 103 sets reference time T1 to time t1 of the first observation data among the above read observation data for the predetermined time and sets comparative time T2 at time t1 next to the time t0 (operation S31). The amount-of-change calculating section 103 reads observation data at the reference time T1 and observation data at the comparative time T2 from the read observation data and calculates the difference therebetween (operation S33). The amount-of-change calculating section 103 then determines whether the calculated difference is greater than or equal to the reference change amount specified in operation S13 (operation S35). If the difference is less than the reference change amount, no notification is performed even if this reference change amount is set. The amount-of-change calculating section 103 moves to operation S41 and shift the comparative time T2. On the other hand, if the difference is greater than or equal to the reference change amount, notification is made if this reference change amount is set. The amount-of-change calculating section 103 increases the counter N by 1 (operation S37) and sets the comparative time T2 to the reference time T1 (operation S39). The amount-of-change calculating section 103 then execute operation S41.

In operation S41, the amount-of-change calculating section 103 sets the next observation time (or reception time) to the comparative time T2. For example, the amount-of-change calculating section 103 adds an interval td between observation times etc. to the comparative time T2 and sets it. The amount-of-change calculating section 103 then determines whether the data for the predetermined time read in operation S11 has been processed (operation S43). If unprocessed data is present, the amount-of-change calculating section 103 returns to operation S33. On the other hand, if all the data has been processed, the amount-of-change calculating section 103 returns to the process of the flowchart in FIG. 7.

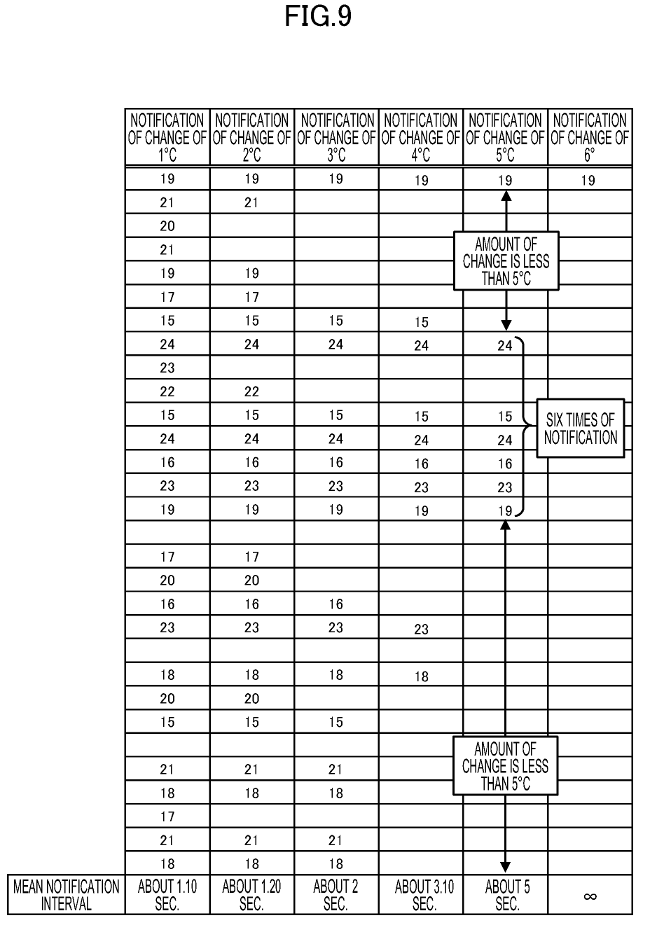

When the process in FIG. 8 in the case where 1° C. is specified as the reference change amount in operation S13 of FIG. 7 is performed, changes greater than or equal to the reference change amount are detected in the example of FIG. 6 except three times, from 11:10:15 to 11:10:16, from 11:10:20 to 11:10:21, and from 11:10:24 to 11:10:25 during which even a change of 1° C. does not occur. Accordingly, as shown in the column of notification of a change of 1° C. in FIG. 9, observation data is notified 26 times, so that N=26 is given. In this embodiment, the first observation data is not included in the count because it is always notified.

For example, when 2° C. is specified as the reference change amount in operation S13 of FIG. 7, observation data at the time when temperature changes by only less than 2° C. is not notified, as shown in the column of notification of a change of 2° C. in FIG. 9.

Furthermore, assume that 3° C. is specified as the reference change amount in operation S13 of FIG. 7. For the observation data as illustrated in FIG. 6, observation data at the time when temperature changes by only less than 3° C. is not notified, as shown in the column of notification of a change of 3° C. in FIG. 9, so that N=15 holds. Furthermore, assuming that 4° C. is specified as the reference change amount, observation data at the time when temperature changes by only less than 4° C. is not notified, as shown in the column of notification of a change of 4° C. in FIG. 9, so that N=9 holds in the example of FIG. 6. Assuming that 5° C. is specified as the reference change amount, observation data at the time when temperature changes by only less than 5° C. is not notified, as shown in the column of notification of a change of 5° C. in FIG. 9, so that N=6 holds in the example of FIG. 6. If the reference change amount is 6° C., only the first observation data is notified, so that N=0 holds.

For the notification of a change of 5° C., as indicated in FIG. 9, notifications are sometimes concentrated to time periods when changes in temperature are great, i.e., six times, and few notifications are made before and after that. However, with any reference change amount, frequent great temperature changes are frequently notified. Therefore, a process for obtaining a mean notification time interval is performed.

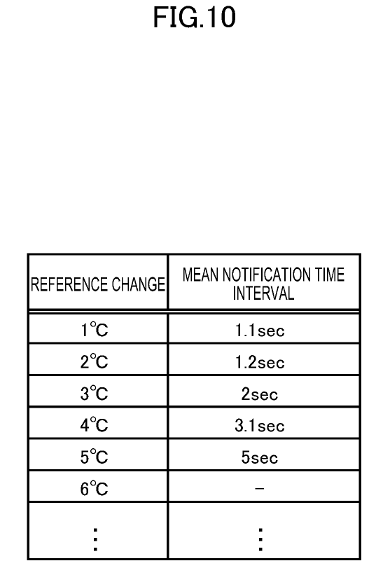

Referring to FIG. 7, the amount-of-change calculating section 103 divides the predetermined time by N obtained above to calculate mean notification time intervals for the individual reference change amounts and registers the mean notification time intervals in the amount-of-change DB 104 in association with the reference change amounts (operation S19). Data as illustrated in FIG. 10 is stored for each sensor. In the example of FIG. 10, mean notification time intervals are registered for the individual reference change amounts. The amount-of-change calculating section 103 then determines whether all the reference change amounts have been processed (operation S21). If an unprocessed reference change amount is present, the amount-of-change calculating section 103 returns to operation S13. In contrast, if an unprocessed reference change amount is absent, the amount-of-change DB creating process is terminated.

By performing the above process, the history data of the observation data in the observation-data DB 102 is converted to the notification-time-interval data for the individual changes in the amount-of-change DB 104, as illustrated in the FIG. 3.

Although temperature is used above as an example, one-dimensional observation data, such as humidity, air volume, inclination, acceleration, speed, light quantity, and sound level, can also be processed as in the above. On the other hand, (two dimensional or three dimensional) position coordinates, color data of images (RGB, HSV, Luv, and Lab), can be processed as in the processing flow described above. For example, by calculating evaluation indexes based on a plurality of values included in observation data at each of reference time and comparative time, calculating the difference between the calculated evaluation indexes, and comparing the difference with a reference change amount. The evaluation indexes may be calculated using an expression, such as (x²+y²)^{1/2}, or alternatively, by a simple expression, such as x+y. This also applies to dimensions greater than the three dimensions. For images, an evaluation index, such as the area of a pixel or region in which color has changed by a threshold value or more may be adopted. Other examples will be described later.

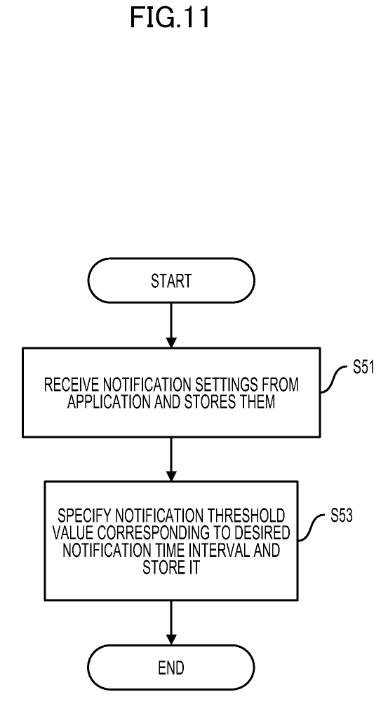

The process of the notification processing section 106 will be described with reference to FIGS. 11 to 14. First, a process when the notification processing section 106 has received notification settings from, for example, an application program A, will be described with reference to FIG. 11.

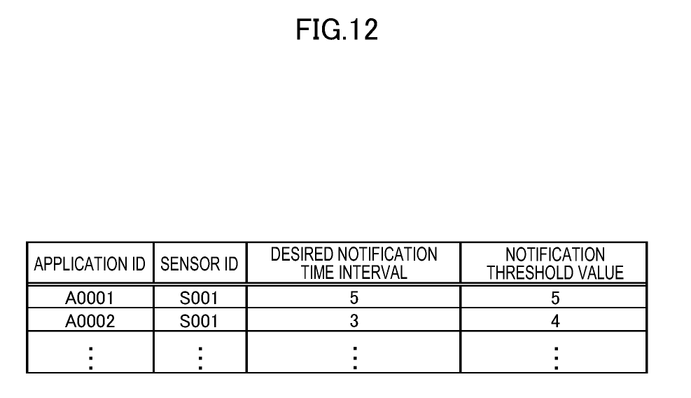

For example, on reception of notification settings including the ID of the application program A, the ID of a target sensor, and a desired notification time interval, at which the application program A can process observation data, from, the application program A, the notification processing section 106 stores the notification settings in the notification time DB 105 (operation S51). The notification time DB 105 stores, for example, the data illustrated in FIG. 12. In the example of FIG. 12, application IDs, sensor IDs, desired notification time intervals, and notification threshold values are registered. At the stage of reception of notification settings, data has not yet been registered in the column of notification threshold values.

Since a plurality of application programs and a plurality of sensors are present, the record is registered for each combination of an application program and a sensor.

The notification processing section 106 specifies, for a sensor ID included in the notification settings, a reference change amount corresponding to a received desired notification time interval as a notification threshold value with reference to the table of the amount-of-change DB 104 and registers the reference change amount in the column of the notification threshold value of the record in the notification time DB 105 created in operation S51 (operation S53). The notification processing section 106 specifies the smallest reference change amount in the records in which values greater than or equal to the desired notification time interval is registered from the mean notification time intervals on a table, as illustrated in FIG. 10. If the desired notification time interval is 5 sec. in the example of FIG. 10, 5° C. is specified.

Thus, a notification threshold value is specified for each combination of an application program and a sensor.

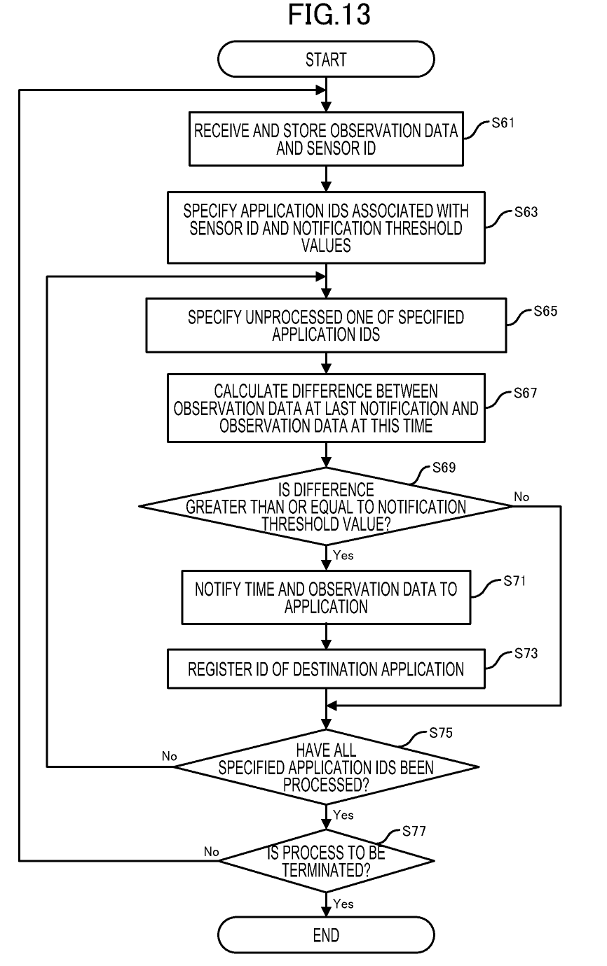

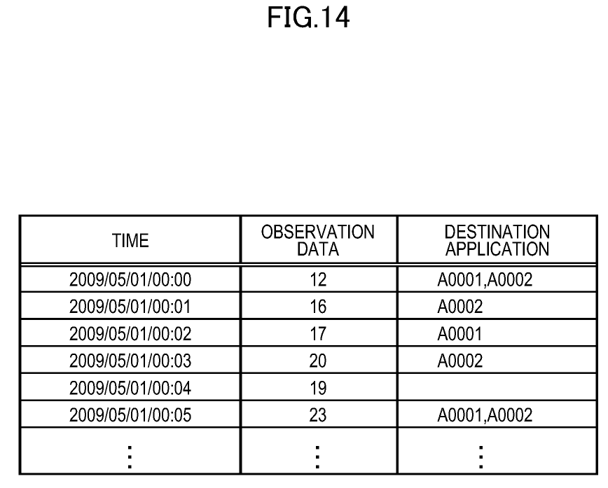

A process when the notification processing section 106 has received observation data from the observation-data collecting section 101 will be described with reference to FIG. 13. On reception of observation data (observation data and time) and a sensor ID from the observation-data collecting section 101, the notification processing section 106 stores the observation data in the cache 107 (operation S61). For example, the cache 107 stores such data as illustrated in FIG. 14 for each sensor ID. FIG. 14 illustrates the data of a sensor having a sensor ID S001 illustrated in FIG. 12. In the example of FIG. 14, time, observation data, and the IDs of destination application programs are registered. The data structure of the cache 107 is merely an example; time and observation data at the last notification may also be stored for each combination of an application program and a sensor.

The notification processing section 106 specifies a notification threshold value for each of applications associated with a sensor ID included in the received observation data with reference to the notification time DB 105 (operation S63). For example, if the received sensor ID is S001, the notification processing section 106 specifies an application ID, A0001, a notification threshold value, 5 sec., and an application ID, A0002, and a notification threshold value, 4 sec.

Then, the notification processing section 106 specifies unprocessed one of the specified application IDs as the object to be processed (operation S65). If no application ID is specified (not illustrated), the notification processing section 106 moves to operation S77. After operation S65, the notification processing section 106 specifies, in the cache 107, observation data at the last notification, with which the specified application ID is associated, and calculates the difference between the last observation data and the present observation data (operation S67). If the observation data includes a plurality of values, as described above, the notification processing section 106 calculates the evaluation indexes of the observation data at the last notification and at this time. The notification processing section 106 then compares the calculated difference with the specified notification threshold value to determine whether the difference is greater than or equal to the notification threshold value (operation S69). If the observation data includes a plurality of values, the notification processing section 106 determines whether the difference between the evaluation indexes is greater than or equal to the notification threshold value. If the difference is less than the notification threshold value, the notification processing section 106 moves to operation S75. On the other hand, if the difference is greater than or equal to the notification threshold value, the notification processing section 106 notifies the present observation data and time to the application program having the specified application ID (operation S71). The notification processing section 106 registers, in the cache 107, the ID of the destination application program in association with the present observation data and time (operation S73). In the example of FIG. 14, the notification processing section 106 registers the corresponding ID in the column of destination in the record of the present registered observation data.

The notification processing section 106 then determines whether all the application IDs specified in operation S63 have been processed (operation S75). If an unprocessed application ID is present, the notification processing section 106 returns to operation S65. On the other hand, if all the specified application IDs have been processed, the notification processing section 106 determines whether an instruction to terminate the process has been given (operation S77). When the instruction to terminate the process has not been given, the notification processing section 106 returns to operation S61. On the other hand, if the instruction to terminate the process is given, the process is terminated.

This process allows observation data to be notified to each application program at appropriate timing corresponding to the desired notification time interval of the application program.

FIGS. 13 and 14 illustrate a process. Assume that, for the application program A having the application ID, A0001, the notification threshold value is 5° C., and for an application program B having the application ID, A0002, the notification threshold value is 4° C., as illustrated in FIG. 12. The observation data is 12° C. at 00:00 May 1, 2009, at which notification is started, so that the application programs A and B are notified of the observation data. The observation data is 16° C. at 00:01 May, 1, 2009, at which the difference between 16° C. and 12° C. at the last notification to the application program B is 4° C., which is equal to the notification threshold value 4° C., so that the application program B is notified of the observation data. On the other hand, the application program A is not notified because the difference 4° C. is less than the notification threshold value 5° C. The observation data is 17° C. at 00:02 May, 1, 2009, at which the difference between 17° C. and 12° C. at the last notification to the application program A is 5° C., which is equal to the notification threshold value 5° C., so that the application program A is notified of the observation data. On the other hand, the application program B is not notified because the difference from the observation data 16° C. at the last notification is 1° C. The observation data is 20° C. at 00:03 May, 1, 2009, at which the difference between 20° C. and 16° C. at the last notification to the application program B is 4° C., which is equal to the notification threshold value 4° C., so that the application program B is notified of the observation data. On the other hand, the application program A is not notified because the difference from the observation data 17° C. at the last notification is 3° C. The observation data is 19° C. at 00:04 May 1, 2009, at which the differences 2° C. and 1° C. between 19° C. and the observation data 17° C. and 20° C. at the last notification to the application programs A and B are not greater than or equal to the respective notification threshold values 5° C. and 4° C. Then the application programs A and B are not notified of the observation data. The observation data is 23° C. at 00:05 May 1, 2009, at which the difference between 23° C. and 17° C. at the last notification to the application program A is 6° C., which is greater than the notification threshold value 5° C., so that the application program A is notified of the observation data. On the other hand, the application program B is not notified because the difference between 23° C. and 20° C. at the last notification to the application program B is 3° C., which is less than the notification threshold value 4° C. These processes may be executed in sequence.

Since the capacity of the cache 107 is limited, old data is discarded in sequence and is updated by newly received observation data or the like.

The process of FIG. 13 may be threaded for each sensor ID.

The sensors in this embodiment are temperature sensors mounted to, for example, the server racks of a data center, and the application programs are temperature-monitoring application programs for controlling a fan for regulating temperature in, for example, the server racks, transmitting a warning by email, or the like. The data center has a plurality of server racks, and observation data is notified from a large number of temperature sensors to the management system 1.

Assume that the temperature-monitoring application program can accept 20 notifications/sec., for example. Then, the temperature-monitoring application program can accept a notification per 0.05 sec. if only one temperature sensor is used. However, if the number of sensors monitored by the temperature-monitoring application program increases, a desired notification time interval needs to be increased correspondingly. This is because an increase in the number of application programs is not practical in terms of cost. The use of two sensors requires 0.1 sec./sensor, 10 sensors requires 0.5 sec./sensor, and 100 sensors requires 5 sec./sensor.

If observation data is thinned out at simple time intervals when notification is requested at such time intervals, significant changes, as illustrated in FIG. 1, could be overlooked. Thus, a reference change amount, which is a data change to be notified, and a notification time interval are obtained based on the history of the observation data. Thus, a notification threshold value for use in notification is specified based on the reference change amount, the notification time interval, and time intervals of notification that can be processed by the application program.

This embodiment can be applied not only to such a data center but also to control of fans and heaters necessary for equipment and systems for agriculture and fishery that are easily influenced by nature; more specifically, control of equipment for greenhouses and indoor culture, frost-preventing air blowers on tea plantations, etc.

The amount-of-change DB 104 may be updated regularly or if an update instruction is given from an administrator or the like because observation data stored in the observation-data DB 102 actually changes momentarily.

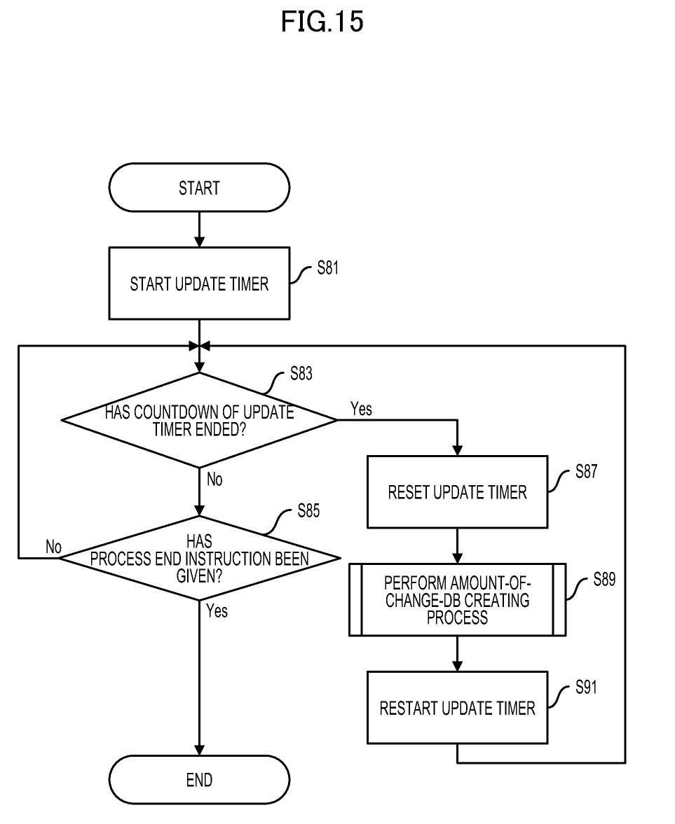

A process for regularly updating the amount-of-change DB 104 will be described hereinafter. The process of the amount-of-change calculating section 103 will be described with reference to FIG. 15. The amount-of-change calculating section 103 starts the countdown of an update timer that is a countdown timer (operation S81). The amount-of-change calculating section 103 then determines whether the countdown of the update timer has ended, that is, whether the timer value has become 0 (operation S83). If the countdown has not ended, the amount-of-change calculating section 103 determines whether an instruction to end the process has been given from an administrator or the like (operation S85). If an end instruction has been given, the variation calculating section 103 terminates the process, and if an end instruction has not been given, the variation calculating section 103 returns to operation S83.

On the other hand, when the countdown has ended, the amount-of-change calculating section 103 resets the update timer (operation S87) and performs the amount-of-change-DB creating process illustrated in FIG. 7 (operation S89). The process in FIG. 7 is executed for each sensor ID. Thereafter, the amount-of-change calculating section 103 starts the countdown of the update timer again (operation S91) and returns to operation S83.

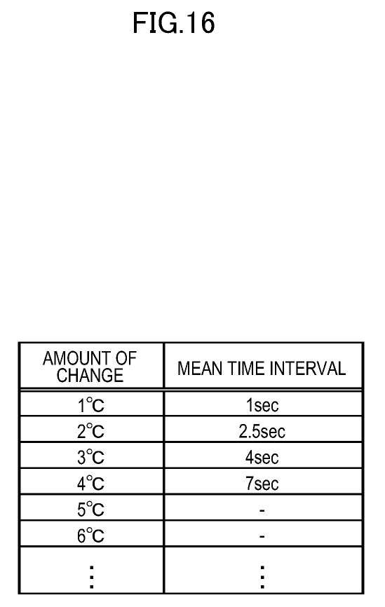

Thus, the data in the amount-of-change DB 104 as illustrated in FIG. 10 is updated to such data as illustrated in FIG. 16.

With the update of the data in the amount-of-change DB 104, the notification threshold value for use in determining whether to notify the observation data to the application program is updated.

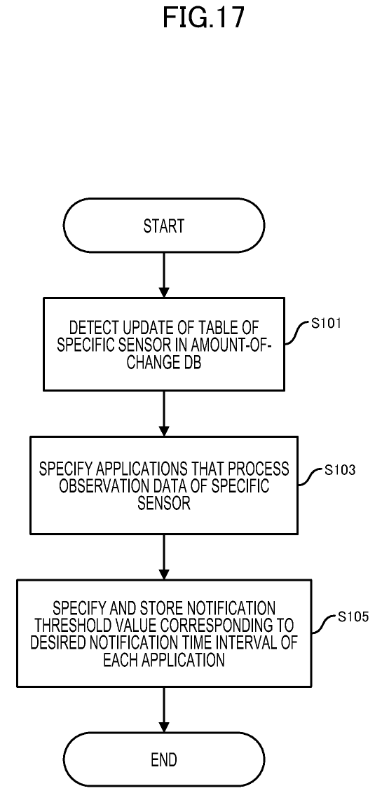

Accordingly, the notification processing section 106 performs the process illustrated in FIG. 17. Upon detection of the update of a table for a specific sensor in the amount-of-change DB 104 (operation S101), the notification processing section 106 specifies application IDs with which the ID of the specific sensor is associated to specify application programs that process the observation data of the specific sensor (operation S103). The notification processing section 106 then specifies a reference change amount corresponding to a mean notification time interval corresponding to a desired notification time interval registered in association with each specified individual application ID as a new notification threshold value and resisters the value in the notification time DB 105 (operation S105). In other words, the notification processing section 106 specifies the smallest reference change amount of the records in which mean notification time intervals longer than the desired notification time interval are registered.

This allows notification timing to be updated in response to the update of data in the amount-of-change DB 104.

For the application program A in FIG. 12, the desired notification time interval is 5 sec. Therefore, on the table in FIG. 10, 5° C. is specified as the notification threshold value; however, on the table of FIG. 16, 4° C. is specified as the notification threshold value. For the application program B in FIG. 12, the desired notification time interval is 3 sec. Therefore, on the table in FIG. 10, 4° C. is specified as the notification threshold value; however, on the table of FIG. 16, 3° C. is specified as the notification threshold value. The notification threshold value is updated in that way, and the notification timing is also updated.

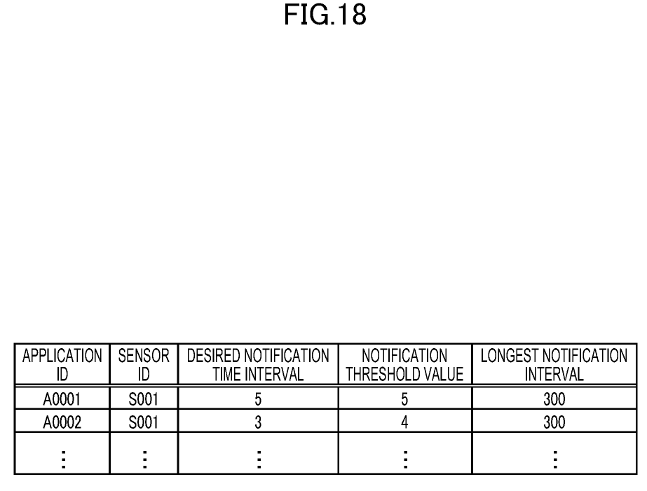

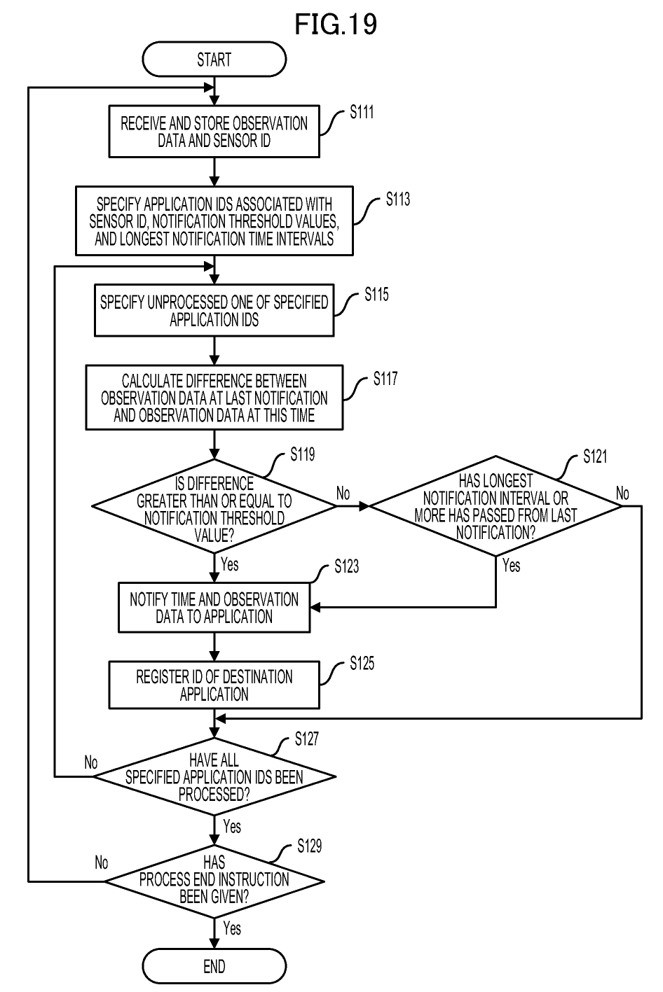

In the processing flow described in FIG. 13, the application program may not be notified for a long time if the difference between observation data at the last notification and observation data at this notification is continuously less than the notification threshold value. On the other hand, even if there is a request for notification to the application program at least every three minutes, this processing flow cannot comply with the request. However, the process illustrated in FIG. 19 can comply with such a request provided that data of the longest notification time interval is included in the notification settings, for example, in operation S51 of FIG. 11. In such a case, such data as illustrated in FIG. 18 is registered in the notification time DB 105. In other words, the column of the longest notification interval is provided, the values of which are registered for application programs that designate the longest notification interval.

Referring next to the process in FIG. 19, upon reception of observation data (observation data and time) and a sensor ID from the observation-data collecting section 101, the notification processing section 106 stores the observation data in the cache 107 (operation S111).

The notification processing section 106 specifies application IDs associated with the received sensor ID, notification threshold values, and longest notification intervals in the notification time DB 105 (operation S113). The notification processing section 106 specifies unprocessed one of the specified application IDs (operation S115). If no application ID is specified (not illustrated), the notification processing section 106 moves to operation S129. Thereafter, the notification processing section 106 specifies, in the cache 107, observation data at the last notification with which the specified application ID is associated and calculates the difference between the last observation data and the present observation data (operation S117). The notification processing section 106 then compares the calculated difference with the specified notification threshold value to determine whether the difference is greater than or equal to the notification threshold value (operation S119). If the observation data includes a plurality of values, as described above, the notification processing section 106 calculates evaluation indexes using a predetermined valuation expression and compares the difference between the evaluation indexes with the notification threshold value.

If the difference is less than the notification threshold value, the notification processing section 106 determines whether the longest notification interval or more has passed from the last notification (operation S121). If the longest notification interval or more has not passed from the last notification, the notification processing section 106 moves to operation S127. On the other hand, if it is determined in operation S119 that the difference is greater than or equal to the notification threshold value or if it is determined in operation S121 that the longest notification interval or more has passed from the last notification, the notification processing section 106 notifies this observation data and time to the application program having the specified application ID (operation S123).

The notification processing section 106 registers, in the cache 107, the ID of the destination application program in association with the present observation data and time (operation S125). The notification processing section 106 determines whether all the application IDs specified in operation S113 have been processed (operation S127). If an unprocessed application ID is present, the notification processing section 106 returns to operation S115. On the other hand, if all the specified application IDs have been processed, the notification processing section 106 determines whether an instruction to terminate the process has been given (operation S129). If an instruction to terminate the process has not been given, the notification processing section 106 returns to operation S111. On the other hand, when an instruction to terminate the process has been given, the process is terminated.

Execution of this process can cope with the case where the longest notification interval is set.

Although the notification counting process described with reference to FIG. 8 can be applied to the case where the observation data includes only one value or one evaluation index is calculated from observation data for use, the amount of change should be determined for individual components of position coordinates including the x-coordinate and the y-coordinate in some cases. For example, many fields are rectangular. Therefore, comparison of changes appropriate to the shape of the field is easier by determining the changes separately for the x-coordinate and the y-coordinate than determining whether observation data is within the circle of notification threshold values around the coordinate of the last notification time, like a moving distance. This allows determination on transfer to and from one section of the field, operations in the field, etc.

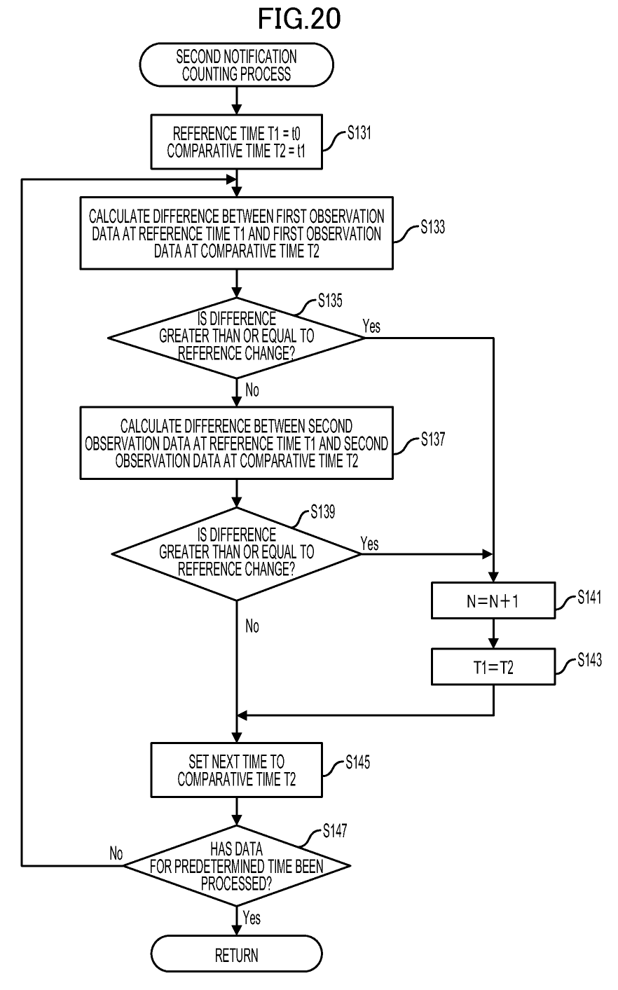

In such a case, a second notification counting process as illustrated in FIG. 20 is performed. The amount-of-change calculating section 103 sets reference time T1 to the first time t0 of the above predetermined time and sets comparative time T2 to time t1 next to the time t0 (operation S131). The amount-of-change calculating section 103 searches read data for first observation data at the reference time T1 and first observation data at the comparative time T2. And calculates the difference therebetween (operation S133). An example of the first observation data is an x-coordinate value or a y-coordinate value.

The amount-of-change calculating section 103 determines whether the calculated difference is greater than or equal to the reference change amount specified in operation S13 (operation S135). The reference change amount may be either a reference change amount of the first observation data or a reference change amount common to the first and second observation data. If the difference is greater than or equal to the reference change amount, the amount-of-change calculating section 103 moves to operation S141. On the other hand, if the difference is less than the reference change amount, the amount-of-change calculating section 103 searches the read data for second observation data at the reference time T1 and second observation data at the comparative time T2 and calculates the difference therebetween (operation S137). An example of the second observation data is a y-coordinate value. The amount-of-change calculating section 103 then determines whether the calculated difference is greater than or equal to the reference change amount specified in operation S13 (operation S139). If the calculated difference is less than the reference change amount, no notification is made even if this reference change amount is set. The amount-of-change calculating section 103 moves to operation S145 and shifts the comparative time T2.

On the other hand, if it is determined in operation S135 or S139 that the difference is greater than or equal to the reference change amount, a notification is made if this reference change amount is set. Thus, the amount-of-change calculating section 103 increases the counter N by 1 (operation S141) and sets the comparative time T2 to the reference time T1 (operation S143). The amount-of-change calculating section 103 then moves to operation S145.

In operation S145, the amount-of-change calculating section 103 sets the next observation time (or reception time) to the comparative time T2. For example, the amount-of-change calculating section 103 adds an interval td of observation data or the like to the comparative time T2 and sets it. The amount-of-change calculating section 103 then determines whether the data for the predetermined time read in operation S11 has been processed (operation S147). If unprocessed data is present, the amount-of-change calculating section 103 returns to operation S133. On the other hand, all of the data has been processed, the amount-of-change calculating section 103 returns to the first process.

Thus, if either the first observation data or the second observation data changes by the reference change amount or more, the counter N is increased by 1. This also applies to a case in which observation data includes three or more values.

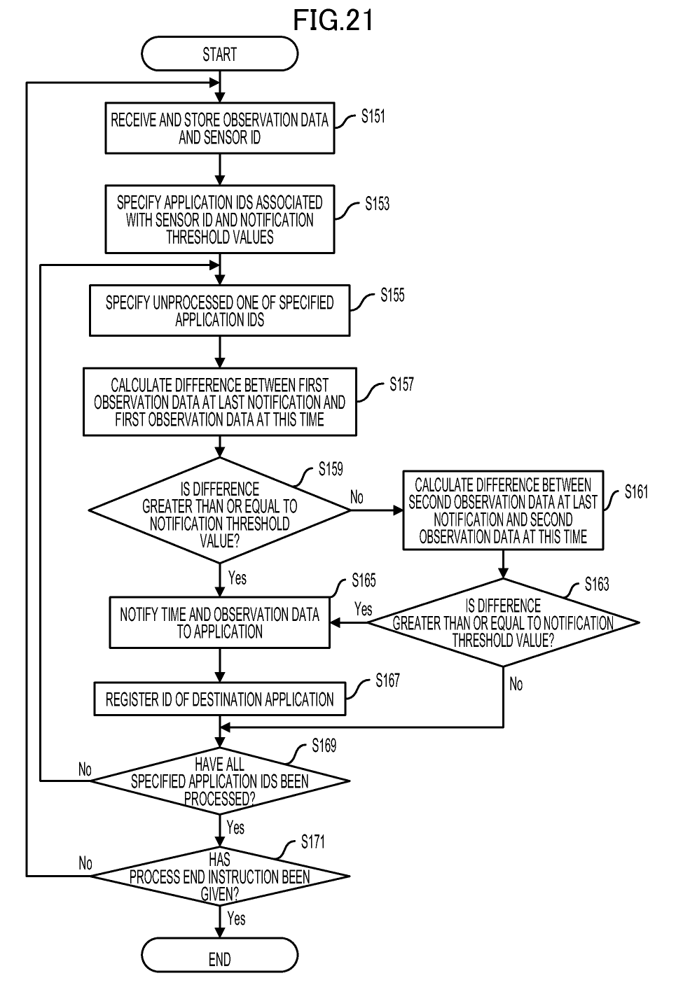

In the process as illustrated in FIG. 20, the notification processing section 106 also performs the process illustrated in FIG. 21 instead of the process in FIG. 13.

Upon reception of observation data (observation data and time) and a sensor ID from the observation-data collecting section 101, the notification processing section 106 stores the observation data in the cache 107 (operation S151).

The notification processing section 106 specifies application IDs associated with the received sensor ID and notification threshold values in the notification time DB 105 (operation S153). The notification threshold values are sometimes provided separately for the first observation data and the second observation data.

The notification processing section 106 then specifies unprocessed one of the specified application IDs (operation S155). If not even one application ID is specified (not illustrated), the notification processing section 106 moves to operation S171. Thereafter, the notification processing section 106 specifies, in the cache 107, the first observation data at the last notification with which the specified application ID is associated and calculates the difference between the first observation data at the last notification and the first observation data at this time (operation S157). The notification processing section 106 compares the calculated difference with the specified notification threshold value to determine whether the difference is greater than or equal to the notification threshold value (operation S159). If the difference is greater than or equal to the notification threshold value, the notification processing section 106 moves to operation S165. On the other hand, if the difference is less than the notification threshold value, the notification processing section 106 specifies, in the cache 107, the second observation data at the last notification with which the specified application ID is associated and calculates the difference between the second observation data at the last notification and the second observation data at this time (operation S161). The notification processing section 106 compares the calculated difference with the specified notification threshold value to determine whether the difference is greater than or equal to the notification threshold value (operation S163). If the difference is greater than or equal to the threshold value, the notification processing section 106 moves to operation S165. On the other hand, if the difference is less than the threshold value, the notification processing section 106 moves to operation S169.

If the difference is greater than or equal to the notification threshold value in operation S159 or S163, the notification processing section 106 notifies the observation data and time at this time to the application program having the specified application ID (operation S165). The notification processing section 106 registers, in the cache 107, the ID of the destination application program in association with the observation data and the time at this time (operation S167).

If it is determined after operation S167 or at operation S163 that the difference is less than the notification threshold value, the notification processing section 106 determines whether all the application IDs specified in operation S153 have been processed (operation S169). If an unprocessed application ID is present, the notification processing section 106 returns to operation S155. On the other hand, if all the specified application IDs have been processed, the notification processing section 106 determines whether an instruction to terminate the process has been given (operation S171). If an instruction to terminate the process has not been given, the notification processing section 106 returns to operation S151. On the other hand, an instruction to terminate the process has been given, the process is terminated.

Thus, even for observation data including two values, this process allows determination whether the individual values have exceeded a notification threshold value and notification to be performed based on the determination. This also applies to observation data having three or more values.

The illustrated embodiments are not limited thereto; for example, the functional block illustrated in FIG. 4 does not necessarily correspond to an actual program module. Furthermore, the processing flow may be changed in processing order or may be executed in parallel provided that the processing result is not changed.

Furthermore, the sensors are not limited to the above example but may be various types of sensors. The sensors may be disposed either in the vicinity of the management system 1 or at distant places.

Although the application programs A to M are implemented by the management system 1, the application programs A to M may be executed by a plurality of computers connected via a network. Part of the functions may be executed by a plurality of computers depending on the application programs.

Although FIGS. 20 and 21 illustrate an example in which notification is made provided that either the first value or the second value is greater than or equal to a notification threshold value, a process in which notification is made if both of the first value an the second value are greater than or equal to a notification threshold value.

Furthermore, although an example in which the difference between the evaluation index of observation data at the last notification and the evaluation index of observation data at this time is calculated is shown, comparison between an evaluation index corresponding to the difference between observation data and a notification threshold value may be performed. The valuation expression can be defined variously depending on the characteristics of sensor observation data.

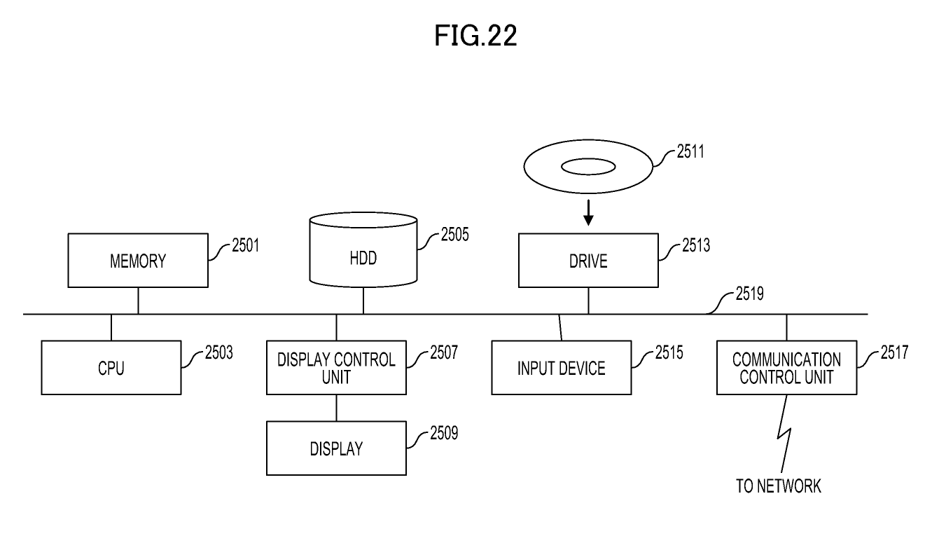

The above management system 1 may be achieved by a computer as illustrated in FIG. 22.

This computer includes a memory 2501, a CPU 2503, a hard disk drive (HDD) 2505, a display control unit 2507 connected to a display 2509, a drive 2513 for a removable disk 2511, an input device 2515, and a communication control unit 2517 for connection with a network, which are connected via a bus 2519.

An operating system (OS) and application programs for executing the processes of the embodiments are stored in the HDD 2505, and for execution by the CPU 2503, the application programs may be read from the HDD 2505 into the memory 2501. The CPU 2503 controls the display control unit 2507, the communication control unit 2517, and the drive 2513 as necessary to make them perform necessary operations. Data in process is stored in the memory 2501 or in the HDD 2505 as necessary.

Exemplary application programs for executing the above processes are stored in the computer-readable removable disk 2511 and are distributed, and are installed in the HDD 2505 via the drive 2513. The application programs are sometimes installed in the HDD 2505 via a network, such as the Internet, through the communication control unit 2517. Such a computer achieves the above various functions in such a manner that exemplary hardware, such as the CPU 2503 and the memory 2501, the OS, and necessary application programs cooperate organically.

A program for making the computer execute the programs described above can be created. The program is stored in a computer-readable, non-transitory storage medium or storage unit, such as a flexible disk, a CD-ROM, a magneto-optical disk, a semiconductor memory, or a hard disk. Data in process is temporarily stored in the storage unit, such as a memory, of the computer.

The embodiments allow sensor observation data to be notified to application programs if a change in sensor observation data exceeds a threshold value while appropriately limiting the amount of notification in consideration of the processing time of the application programs.

The embodiments allow observation data to be notified to application programs in such a manner that a notification time intervals designated for the application programs are substantially satisfied also when a change greater than or equal to a reference change amount specified based on the designated notification time intervals suddenly occurs. In other words, the embodiments allows notifications to the application programs at appropriate intervals and timing. The notification may be either a notification of the occurrence of an event or a notification including observation data or observation data and time.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A notifying method executed by a computer for notifying observation data observed by a sensor to an application program, the method comprising:
storing the observation data received from the sensor and time information corresponding to the observation data;
calculating notification time intervals, for each amount of change in observation data, based on the observation data and the time information, in a case where the observation data is notified to the application program only when the observation data changes by a value which is greater than or equal to the amount of change in observation data;
storing the calculated notification time intervals in association with each of the amount of change;
obtaining a designated notification time interval from the application program;
specifying the smallest notification time interval which is greater than or equal to the obtained designated notification time interval from among the notification time intervals;
specifying an amount of change stored in association with the specified notification time interval as a reference change amount;
on receiving newest observation data from the sensor, calculating amount-of-change evaluation data based on the newest observation data and observation data notified to the application program at last notification;
determining whether the calculated amount-of-change evaluation data is greater than or equal to the specified reference change amount; and
notifying the observation data received from the sensor to the application program, when it is determined in the determination that the amount-of-change evaluation data is greater than or equal to the reference change amount.

2. The method according to claim 1, further comprising:
notifying the newest observation data received from the sensor to the application program, on condition that the amount-of-change evaluation data is determined to be less than the reference change amount and a second designated notification time interval obtained from the application program has passed from the last notification to the application program.

3. The method according to claim 1, wherein
the amount-of-change evaluation data is
the difference between the newest observation data received from the sensor and observation data notified to the application program at the last notification,
the difference between the evaluation index of the newest observation data received from the sensor and the evaluation index of observation data notified to the application program at the last notification,
difference evaluation data which evaluates the difference between the observation data received from the sensor and observation data notified to the application program at the last notification, or
when the observation data includes two or more values, the difference between one of the values of the newest observation data received from the sensor and the one of the values of observation data notified to the application program at the last notification.

4. The method according to claim 1, wherein
the calculation of the notification time intervals further including:
counting the number of times of notification of observation data to the application program during a fixed period, for each amount of change in observation data, based on observation data observed during the fixed period, in a case where notification is made only when observation data changes by a value greater than or equal to the amounts of change in observation data; and
calculating the notification time interval by dividing the period by the number of times.

5. An apparatus for notifying observation data observed by a sensor to an application program, the apparatus comprising:
an observation data memory which stores the observation data received from the sensor and time information corresponding to the observation data;
a notification-time-interval calculating unit which calculates notification time intervals, for each amount of change in observation data, based on the observation data and the time information stored in the observation data memory, in a case where the observation data is notified to the application program only when the observation data changes by a value which is greater than or equal to the amount of change in observation data;
an amount-of-change data memory which stores the notification time intervals calculated by the notification-time-interval calculating unit in association with each of the individual amount of change;
an acquisition unit which obtains a designated notification time interval from the application program;
a first specification unit which specifies the smallest notification time interval which is greater than or equal to the designated notification time interval obtained from the acquisition unit from among the notification time intervals with reference to the amount-of-change data memory;
a second specification unit which specifies, as a reference change amount, an amount of change corresponding to the smallest notification time interval specified by the first specification unit with reference to the amount-of-change data memory;
an evaluation-data calculating unit which calculates, on receiving newest observation data from the sensor, amount-of-change evaluation data based on the newest observation data and observation data notified to the application program at last notification;
a determination unit which determines whether the amount-of-change evaluation data calculated by the evaluation-data calculating unit is greater than or equal to the reference change amount specified by the second specification unit; and
a notification unit which notifies the newest observation data received from the sensor to the application program when the determination unit determines that the amount-of-change evaluation data is greater than or equal to the reference change amount.

6. A method executed by a computer for providing data, the method comprising:
storing observation data received from a sensor and corresponding time information corresponding to the observation data;
calculating time intervals for each amount of change in the observation data in a case where the observation data is provided to a user only when the observation data changes by a value which is greater than or equal to an amount of change in observation data;
storing the calculated time intervals in association with each of the respective amounts of change;
specifying a smallest time interval which is greater than or equal to a designated time interval from among the time intervals;
specifying an amount of change stored in association with the specified time interval as a reference change amount;
on receiving new observation data, calculating amount-of-change evaluation data based on the new observation data and observation data provided to the user at a last notification;
determining whether the calculated amount-of-change evaluation data is greater than or equal to the specified reference change amount; and
providing the observation data received from the sensor to the user, when it is determined that the amount-of-change evaluation data is greater than or equal to the reference change amount.
